(19) United States
(12) Patent Application Publication
(10) Pub. No.: US 2025/0265728 A1
(43) Pub. Date: Aug. 21, 2025

(54) PROJECTING PIXELS ONTO TERRAIN

(71) Applicant: Ag Leader Technology, Inc., Ames, IA (US)

(72) Inventors: Trent Anagnostopoulos, Ankeny, IA (US); Josue Calderon, Apex, NC (US)

(73) Assignee: Ag Leader Technology, Inc., Ames, IA (US)

(21) Appl. No.: 19/057,707

(22) Filed: Feb. 19, 2025

Related U.S. Application Data
(60) Provisional application No. 63/555,547, filed on Feb. 20, 2024.

(51) Int. Cl. G06T 7/73; G01S 19/49; G06V 20/10

(52) U.S. Cl. CPC G06T 7/73; G01S 19/49; G06V 20/188; G06T 2207/30188

(57) ABSTRACT

A method for visually determining a position within a global coordinate system for a feature of interest which includes providing a camera operatively connected to an object, determining a position of the object within the global coordinate system, determining orientation of the object, determining a camera position for the camera and a camera orientation for the camera based on position offset from the position of the object within the global coordinate system and orientation offset from the orientation of the object, acquiring imagery from the camera, the imagery including the feature of interest, at a processor, combining depth sensor data associated with the imagery, pixel location of the feature of interest from the imagery, the camera position, the camera orientation, the position of the object within the global coordinate system, and the orientation of the object to locate the feature of interest within the global coordinate system.

### RELATED APPLICATIONS

This application claims priority to U.S. provisional patent application No. 63/555,547, filed Feb. 20, 2024 and entitled “PROJECTING PIXELS ONTO TERRAIN” which is hereby incorporated by reference in its entirety.

### FIELD OF THE DISCLOSURE

The present disclosure relates to finding features of interest using cameras on objects such as vehicles. More particularly, but not exclusively, the present disclosure relates to identifying and locating agricultural features of interests using cameras on agricultural vehicles.

### BACKGROUND

Cameras have been used to identify and locate agricultural features for many years. Multiple systems are sold today which allow guidance through row crops by visually identifying the space between the crop rows. For example, drones are being used to count standing crop, and satellites are estimating end of year yields. Existing systems are also able to identify specific weed species and map their general locations.

However, these systems fail to identify the precise locations for the features of interest. Frequently, the position of the vehicle on which the camera is mounted is assumed to be close enough to the feature that the position of the vehicle is used. In other cases, there is a simple time delay between observing some feature and any adjustment made in response to it. The inexact localization of the feature can lead to improper control, improper application or poor decision making based on flawed data and assumptions. The data often cannot be re-used by follow on vehicles because the assumptions about camera position, speed, and vehicle characteristics do not hold between different vehicles. Finally, various filtering methods and methods of reasoning cannot be performed on the features because their locations, as found, are fixed to the vehicle and do not correspond to their true locations.

### SUMMARY

Therefore, it is a primary object, feature, or advantage to improve on the state of the art.

It is a further object, feature, or advantage to determine the location of a feature in a global coordinate system.

It is a further object, feature, or advantage to provide a methodology suitable for use with a camera mounted on a vehicle traversing terrain such as an agricultural vehicle within a field.

A still further object, feature, or advantage is to provide a methodology that visually identifies and locates features of interest within camera imagery.

Another object, feature, or advantage is to do so more accurately and reliably than alternatives.

Yet another object, feature, or advantage is to provide a method with sufficiently accurate location information such that the data may be reused, such as by subsequent vehicles.

According to one aspect, a process is provided which uses any method of detecting an interesting feature using a camera with any method to detect depth, such as stereographic methods, time of flight, or lidar, which is mounted on any device or vehicle whose global position is known which combines that information to locate that feature in a global coordinate system. A global coordinate system may be defined as any system which is fixed to some known point and does not move over the time of the operation but not limited to Earth fixed coordinate systems. In overview, this process begins by identifying pixels within an image that represent a feature or features of interest, combining those pixel locations with the depth sensor data to generate a 3D vector pointing from the camera to the feature and finally combining the known global coordinate position of the vehicle or device the camera is mounted upon to calculate the feature's position in global coordinates. The vehicle or mounting area's global coordinates may be known from a combination of sensors, such as a GPS and IMU, or in other cases a position which has been surveyed,

According to another aspect, a method for visually determining a position within a global coordinate system for a feature of interest includes providing a camera operatively connected to an object, determining a position of the object within the global coordinate system, determining orientation of the object, determining a camera position for the camera and a camera orientation for the camera based on position offset from the position of the object within the global coordinate system and orientation offset from the orientation of the object, acquiring imagery from the camera, the imagery including the feature of interest, at a processor, combining depth sensor data associated with the imagery, pixel location of the feature of interest from the imagery, the camera position, the camera orientation, the position of the object within the global coordinate system, and the orientation of the object to locate the feature of interest within the global coordinate system.

According to another aspect, a system configured for visually determining a position within a global coordinate system for a feature of interest is provided. The system includes a camera for operatively connecting to an object, a location determining device for determining a position of the object within the global coordinate system and orientation of the object, at least one processor executing instructions to: determine a camera position for the camera and a camera orientation for the camera based on position offset from the position of the object within the global coordinate system and orientation offset from the orientation of the object, acquire imagery from the camera, the imagery including the feature of interest, and combine depth sensor data associated with the imagery, pixel location of the feature of interest from the imagery, the camera position, the camera orientation, the position of the object within the global coordinate system, and the orientation of the object to locate the feature of interest within the global coordinate system.

According to another aspect, a method for performing field operations within a field is provided. The method includes visually determining a position within a global coordinate system for a feature of interest within the field by determining a position of an agricultural machine within the global coordinate system, determining an orientation of the agricultural machine, determining a camera position for a camera secured to the agricultural machine based on position offset from the position of the agricultural machine, determining a camera orientation for the camera based on orientation offset from the agricultural machine, acquiring imagery from the camera including the feature of interest, and combining depth sensor data associated with the imagery, pixel location of the feature of interest from the imagery, the camera position, the camera orientation, the position of the agricultural machine within the global coordinate system, and the orientation of the agricultural machine to locate the feature of interest within the global coordinate system and performing a field operation within the field based on the position within the global coordinate system for the feature of interest. The field operation may be performed in real-time or online such as guidance or spraying for weeds. Alternatively, post processing operations may use such information such as recording where obstacles were, stand count, crop health, etc. Further operations may include, for example, selectively applying an input such as fertilizer based on crop health as recorded in previous applications.

According to another aspect, a method for visually determining a position within a global coordinate system for a feature of interest is provided. The method includes providing a camera operatively connected to an object, determining a position of the object within the global coordinate system, determining orientation of the object, determining a camera position for the camera and a camera orientation for the camera based on position offset from the position of the object within the global coordinate system and orientation offset from the orientation of the object. The method further includes acquiring imagery from the camera, the imagery including the feature of interest. The method further includes at a processor, combining depth data associated with the imagery, pixel location of the feature of interest from the imagery, the camera position, the camera orientation, the position of the object within the global coordinate system, and the orientation of the object to locate the feature of interest within the global coordinate system. The object may be an agricultural machine and the feature of interest may be located within an agricultural field. Pose of the agricultural machine may be determined based on a combination of GPS location data associated with a GPS antenna associated with the agricultural machine and inertial data associated with an inertial measurement unit (IMU) associated with the agricultural machine. The method may further include performing a field operation within the agricultural field based on the position within the global coordinate system for the feature of interest. The field operation may be performed using the agricultural machine. The field operation may be performed during a subsequent field operation by a machine different from the agricultural machine. The agricultural machine may include at least one of an agricultural vehicle and an agricultural implement. The depth data may be determined using a depth sensor associated with the camera. The depth data may be acquired through at least one of time-of-flight sensing, and lidar sensing. The pixel location may be located at a center of the feature of interest.

According to another aspect, a method for visually determining a position within a global coordinate system for a feature of interest in an agricultural field is provided. The method includes determining a position of an agricultural machine within the global coordinate system, determining an orientation of the agricultural machine, and determining a camera position for a camera operatively connected to the agricultural machine and a camera orientation for the camera based on position offset from the position of the agricultural machine within the global coordinate system and orientation offset from the orientation of the agricultural machine. The method further includes acquiring imagery from the camera, the imagery including the feature of interest and at a processor, combining depth data associated with the imagery, pixel location of the feature of interest from the imagery, the camera position, the camera orientation, the position of the agricultural machine within the global coordinate system, and the orientation of the agricultural machine to locate the feature of interest by providing visually derived coordinates within the global coordinate system. The feature of interest may be a plant such as crop plant or weed. The method may further include performing a crop row following operation within the agricultural field wherein the visually derived coordinates for the plant are used in performing the crop row following within the agricultural field. The method may further include performing an agricultural operation within the agricultural field using the visually derived coordinates within the global coordinate system for the feature of interest. The method may further include repeating the steps of the method a plurality of times and for each time storing the visually derived coordinates for use in a subsequent operation. The feature of interest may be a known in-field fiducial and the may further include comparing the visually derived coordinates of the known in-field fiducial to surveyed coordinates for the known in-field fiducial and correcting the visually derived coordinates within the global coordinate system. The position and the orientation of the agricultural machine may be determined based on a combination of GPS location data associated with a GPS antenna associated with the agricultural machine and inertial data associated with an inertial measurement unit (IMU) associated with the agricultural machine. The agricultural machine may include at least one of an agricultural vehicle and an agricultural implement. The depth data may be determined with a depth sensor associated with the camera. The depth data may be acquired through time-of-flight sensing or lidar sensing. The pixel location may be located at a center of the feature of interest.

According to another aspect, a system configured for visually determining a position within a global coordinate system for a feature of interest is provided. The system includes a camera for operatively connecting to an object, a location determining device for determining a position of the object within the global coordinate system and orientation of the object, and at least one processor executing instructions. The instruction are used to determine a camera position for the camera and a camera orientation for the camera based on position offset from the position of the object within the global coordinate system and orientation offset from the orientation of the object, acquire imagery from the camera, the imagery including the feature of interest, and combine depth data associated with the imagery, pixel location of the feature of interest from the imagery, the camera position, the camera orientation, the position of the object within the global coordinate system, and the orientation of the object to locate the feature of interest within the global coordinate system.

The system may further include an agricultural machine wherein the camera is rigidly connected to the agricultural machine. The agricultural machine may include at least one of an agricultural vehicle and an agricultural implement. The camera may be a 3D camera. The depth data may be acquired through at least one of time-of-flight sensing, and lidar sensing. The location determining device may include a GPS receiver and/or an inertial measurement unit.

According to another aspect, a method for performing field operations within a field is provided. The method includes steps of visually determining a position within a global coordinate system for a feature of interest within the field by determining a position of an agricultural machine within the global coordinate system, determining an orientation of the agricultural machine, determining a camera position for a camera secured to the agricultural machine based on position offset from the position of the agricultural machine, determining a camera orientation for the camera based on orientation offset from the agricultural machine, acquiring imagery from the camera including the feature of interest, and combining depth data associated with the imagery, pixel location of the feature of interest from the imagery, the camera position, the camera orientation, the position of the agricultural machine within the global coordinate system, and the orientation of the agricultural machine to locate the feature of interest within the global coordinate system. The method may further include performing a field operation within the field based on the position within the global coordinate system for the feature of interest. The field operation may be performed by the agricultural machine during the same pass or during a subsequent field operation. Alternatively, the field operation may be performed by a machine different from the agricultural machine. The method may further include performing a crop row following operation within the agricultural field wherein the visually derived coordinates for the plant are used in performing the crop row following operation within the agricultural field. The feature of interest may be a known in-field fiducial, and the method may further include comparing the visually derived coordinates of the known in-field fiducial to surveyed coordinates for the known in-field fiducial and correcting the visually derived coordinates within the global coordinate system.

### BRIEF DESCRIPTION OF THE DRAWINGS

FIG. 1 is an overview of the process for converting pixels representing a feature into a global position.

FIG. 2 is an overview of converting pixel coordinates and a depth to a global position.

FIG. 3 illustrates conversion of camera vector to vehicle vector.

FIG. 4 provides a visualization of the Local Tangent Plane (LTP).

FIG. 5A, FIG. 5B, and FIG. 5C illustrate camera, vehicle, and LTP reference frames.

FIG. 6 illustrates differences in curve fits between pixel space and global coordinates.

FIG. 7 is a block diagram of one example of a system which may use the processes described herein.

### DETAILED DESCRIPTION

The present disclosure provides for determining a precise location of a feature of interest. A set of dynamic inputs is used along with a set of camera calibration inputs to determine the location of the feature of interest.

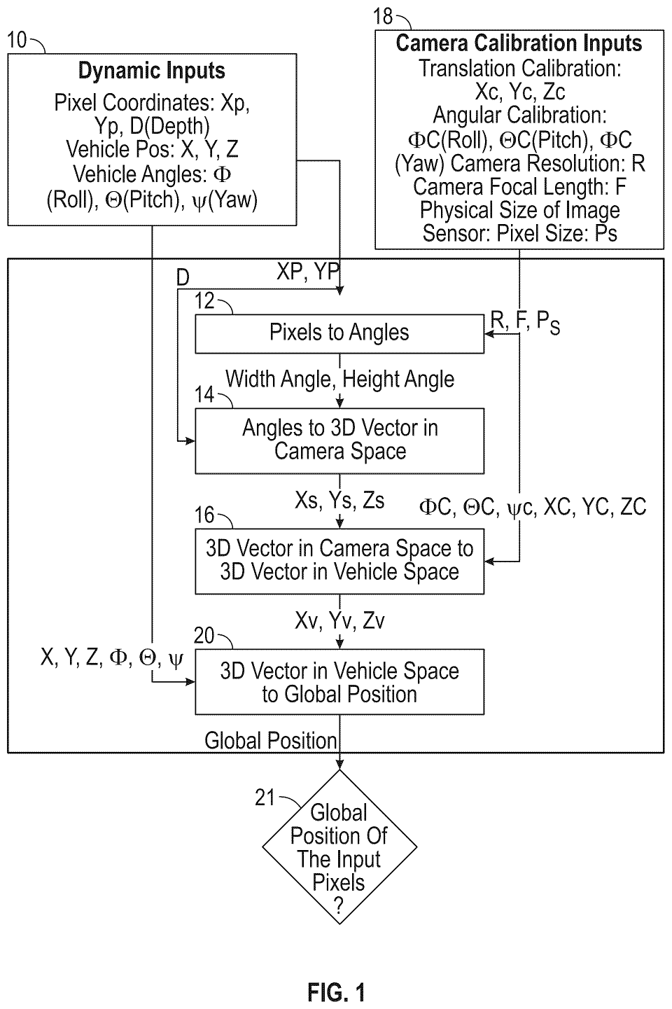

FIG. 1 is an overview of one example of a method in the context of a vehicle. In this example, a camera is rigidly connected to a vehicle (such as a tractor or other agricultural vehicle) which may move through an environment or terrain. The vehicle is a type of object to which the camera may be rigidly connected. Because the vehicle position and vehicle angles change as the vehicle moves, these inputs can be considered dynamic. In addition, in imagery acquired by the camera as the vehicle moves, pixel coordinates and depth (i.e. its distance from the camera) of the feature of interest within the imagery also changes and thus these inputs are also dynamic. It is to be understood that in some applications of the methodology described herein, the vehicle could be in a static position (such as when the vehicle is parked), or else the camera may be connected to a different type of object such as a structure which does not move. Thus, dynamic inputs are not necessarily required to change. In addition, in some applications, both the object (e.g. vehicle) and feature of interest may be moving at the same time. Alternatively, only the feature of interest may be moving, or only the object (e.g. vehicle) may be moving.

In step 10, a set of dynamic inputs are obtained. The dynamic inputs include pixel coordinates, vehicle position, and vehicle angles. The pixel coordinates include an x-position (X_{P}), y-position (Y_{P}), and depth (D). The X and Y pixel coordinates represent the center of the specific feature or interest. The vehicle position includes X, Y, and Z in global coordinates such as geodetic coordinates. The Vehicle Angles include roll, pitch, and yaw in vehicle, Euler, global, or other coordinates.

It is to be understood that any number of different methods may be used for identifying a feature and/or determining that a feature is of interest. This may include methodologies such as thresholding, edge detection, feature detection and description algorithms, region-based segments, morphological operations, histogram analysis, texture analysis, machine learning algorithms such as deep learning, neural networks such as convolutional neural networks, or other types of neural networks or machine learning algorithms. The type of algorithms used may depend upon the type of environment, the type of features of interest, or other contexts or constraints.

Depth can be determined in various ways. For example, stereography or stereo vision may be used where multiple cameras are present (or a single camera provides stereo vision) in order to estimate distance to a feature of interest based on the difference in position of the feature of interest between images from the multiple cameras. Single cameras which provide depth sensing may be referred to as stereo cameras or 3D cameras and such cameras include multiple sensors and calculate depth information.

Time-of-flight (ToF) cameras may also be used to measure depth. The ToF camera may measure the time it takes for light (often infrared light) to travel from a camera to a feature of interest and back thereby allowing for calculation of a distance (depth) to the feature-of interest.

Light Detection and Ranging (Lidar) may be used for depth sensing. Lidar systems emit laser pulses and measure the time it takes for the light to be reflected back thereby allowing for depth to be determined.

Depth estimation may be used. For example, it is also contemplated that depth estimation may be performed such as monocular depth estimates where a machine learning model is trained to infer depth from image content and/or other available information. The machine learning model may be trained based on data from the same or similar application, the same or similar field, the same or similar camera, or otherwise under the same or similar conditions to otherwise provide the most effective machine learning model.

The vehicle position may be determined based on data from a geolocation receiver such as a GPS receiver. In addition, vehicle angles may be determined based on information from the GPS receiver, measurements from an inertial measurement unit (IMU), or a combination of GPS data and IMU data. Other sensors may also be used such as optic flow sensors, load cells, strain gauges, encoders, various angle sensors, etc.to obtain the vehicle's roll and pitch in combination with or instead of an IMU.

In step 18, camera calibration inputs are also obtained including for translation calibration (X_{C}, Y_{C}, Z_{C}), angular calibration including Φ_{c}(roll), Θ_{c}(pitch), Ψ_{c}(yaw), camera resolution (R), cameral focal length (F), physical size of an image sensor, and pixel size, P_{S}. The camera translation calibration is a measurement from a point on the vehicle with a known global position to the position of the camera. The camera angular translation is the roll, pitch, and yaw offset of the camera relative to the vehicle. The camera resolution is the pixel width and pixel height of the output image, such as 1920×1080 or 4 k. The camera focal length describes the distance from the lens where the image converges. The camera pixel size is the physical size of each of the square image sensors which represent each pixel in the output image.

In step 12, a pixels to angles operation is performed. Pixel coordinates (X_{P},Y_{P}) are used along with the cameral resolution, R, the camera focal length, F, and the pixel size, P_{S}, to determine a width angle and a height angle.

This sub-process combines the pixel coordinates with the resolution, focal length, and pixel size to generate an angle from the camera. Note: The following equation may change in sign depending on the location of the origin, (0, 0), in the image.

$${Pixel}_{w i d t h} = {P [ ( \frac{{R}_{w i d t h}}{2} ) - {X}_{p} ]}_{s}$$

$${Pixel}_{h e i g h t} = {P}_{s} [ ( \frac{{R}_{h e i g h t}}{2} ) - {Y}_{p} ]$$

$${Angle}_{w i d t h} = 2 {tan}^{- 1} [ \frac{{Pixel}_{w i d t h}}{2 F} ]$$

$${Angle}_{h e i g h t} = 2 {tan}^{- 1} [ \frac{{Pixel}_{h e i g h t}}{2 F} ]$$

Next in step 14, angles are converted to a 3D vector in camera space. In addition to the width angle and the height angle from step 12, the depth, D, is used. This sub-process executes a change of coordinate system which shifts the 3D vector from reference of the center of the camera to reference of the forward facing direction of the vehicle and to the origin which is the point on the vehicle with known global coordinates. Note: R in the following equations denotes the standard 3D rotation matrix.

$$[ \begin{matrix}{X}_{v} \\ {Y}_{v} \\ {Z}_{v}\end{matrix} ] = R ( {Φ}_{c} , {Θ}_{C} , {Ψ}_{C} ) \cdot [ \begin{matrix}{X}_{S} \\ {Y}_{S} \\ {Z}_{S}\end{matrix} ] + [ \begin{matrix}{X}_{C} \\ {Y}_{C} \\ {Z}_{C}\end{matrix} ]$$

Once the 3D vector (Xs, Ys, Zs) has been obtained in step 14, in step 16 the 3D vector along with the translation calibration (X_{C}, Y_{C}, Z_{C}), angular calibration including Φ_{c}(roll), Θ_{C}(pitch), Ψ_{c}(yaw) are used to determine the 3D vector in vehicle space from the 3D vector in camera space. Thus, the vector Xᵥ,Yᵥ,Zᵥ is obtained.

The sub-process converts the 3D vector pointing from the vehicle to the feature of interest into a global coordinate position of the feature. The process may include any form of global position, but the following shows by example converting to geodetic GPS coordinates.

To reach the geodetic coordinate we first define a Local Tangent Plane. This plane assumes the curvature of the earth is small enough over the relatively small operating distances, a few square miles, to simplify converting vectors into geodetic coordinates.

Here, the process rotates the vehicle space vector into LTP space and shifts the origin from the location on the vehicle where the global position is known to the origin of the LTP.

$$[ \begin{matrix}{X}_{ltp} \\ {Y}_{ltp} \\ {Z}_{ltp}\end{matrix} ] = ( Φ , Θ , Ψ ) \cdot [ \begin{matrix}{X}_{v} \\ {Y}_{v} \\ {Z}_{v}\end{matrix} ] + [ \begin{matrix}X \\ Y \\ Z\end{matrix} ]$$

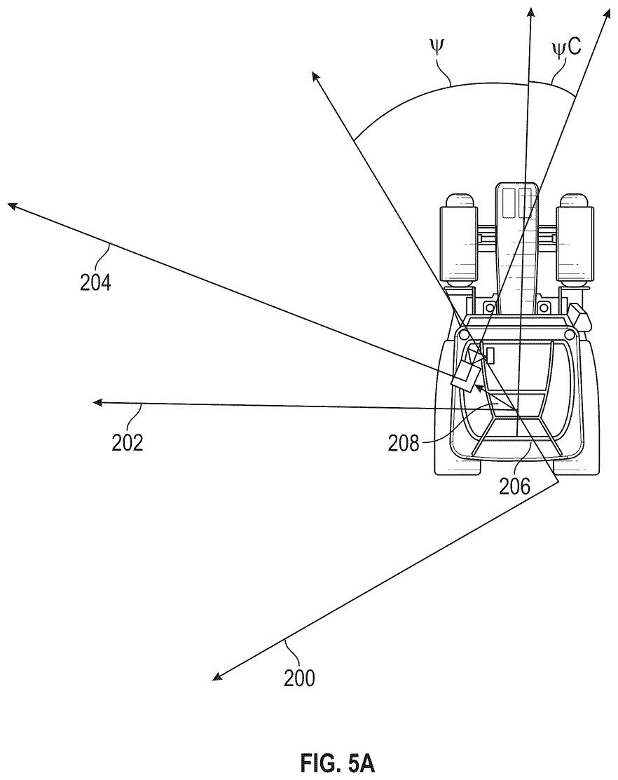

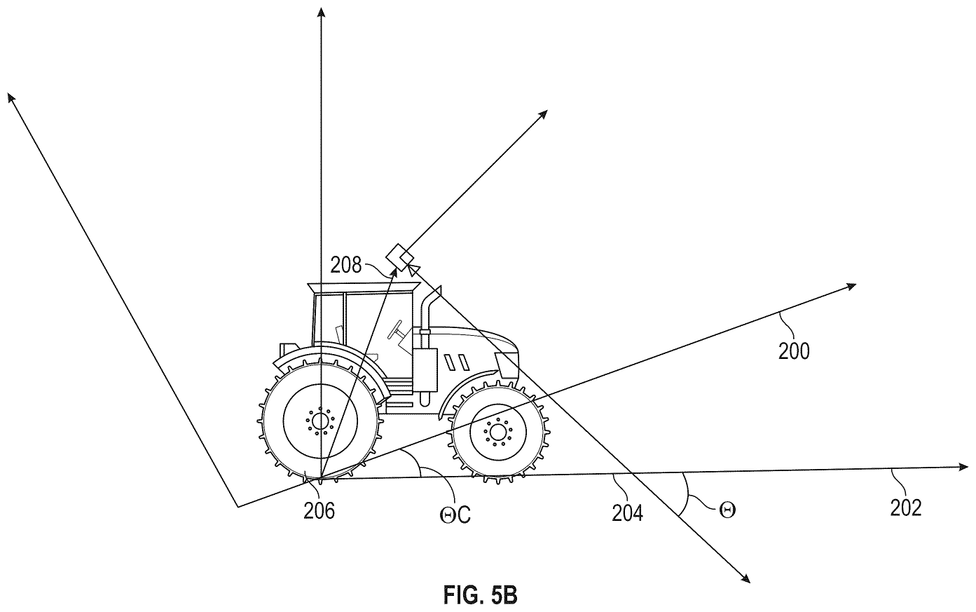

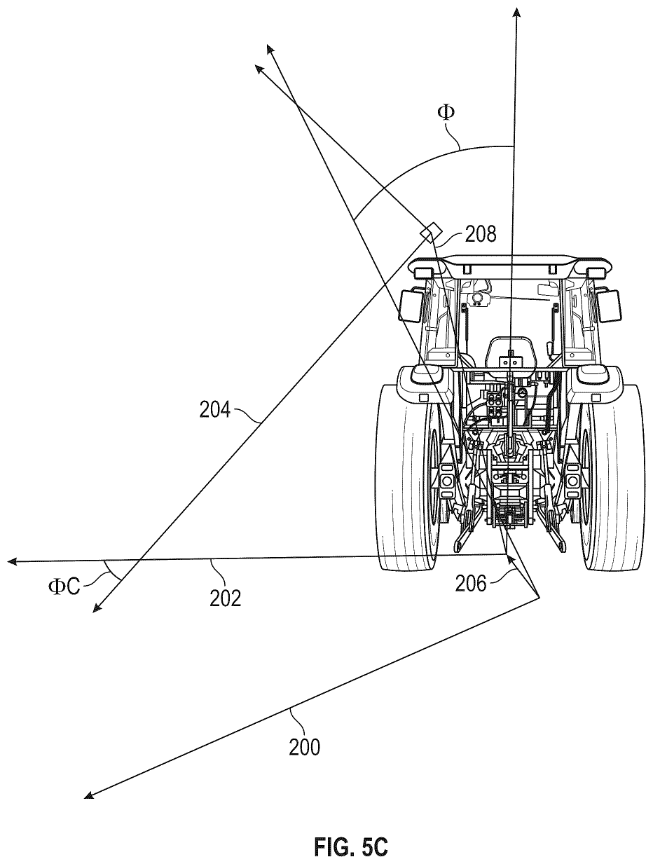

The coordinate systems for the rotations and translations are shown in FIG. 5.

In step 20, the 3D vector in a global coordinate system or global space is obtained from the 3D vector in vehicle space and using X, Y, Z, as well as the roll, pitch, and yaw. The process converts back from LTP to geodetic using well known methods such as the Newton-Raphson method. Thus, the output 21 is the geodetic position of the input pixels associated with a feature of interest.

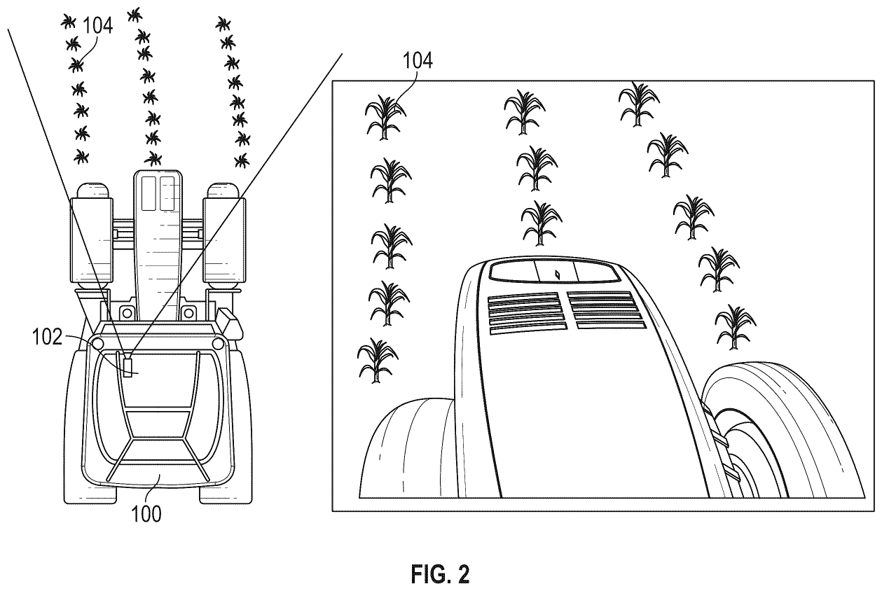

FIG. 2 provides an overview of converting pixel coordinates and a depth to a global position. FIG. 2 illustrates an object in the form of an agricultural vehicle 100 with a camera 102 mounted thereon or otherwise operatively connected. The agricultural vehicle 100 may be positioned within a field and be used in performing a field operation. As shown in FIG. 2 a plurality of rows of crops are shown.

In FIG. 2, pixel coordinates are shown which are associated with a feature of interest, in this instance, a plant such as a corn plant 104. For example, the X,Y coordinates are 200 and 150, respectively, and are associated with imagery of the corn plant 104. In addition, a depth of 7.8 m is associated with the corn plant 104. Also shown in FIG. 2 are the global coordinates for the feature of interest which are 41.973586, −93.625889.

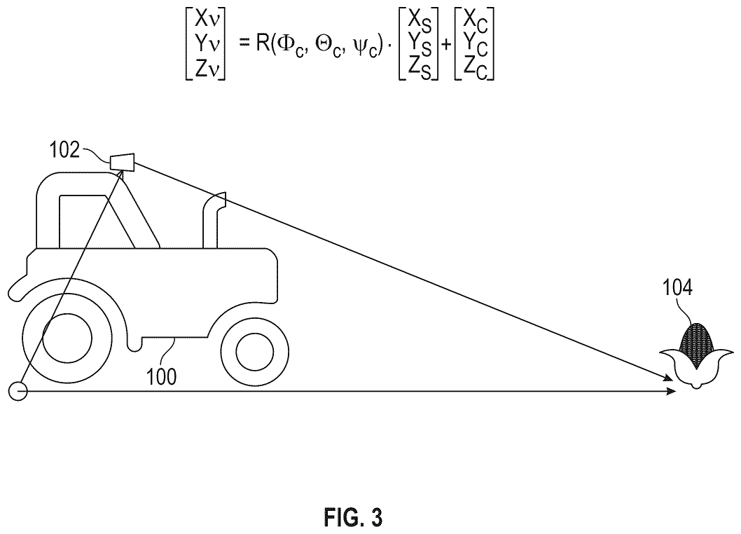

FIG. 3 illustrates conversion of a camera vector to a vehicle vector. A camera 102 is shown mounted to an agricultural machine such as the vehicle 100 with a view from the camera including the feature of interest, corn plant 104. As shown in FIG. 3, the 3D vector is shifted from reference of the center of the camera to reference of the forward facing direction of the vehicle.

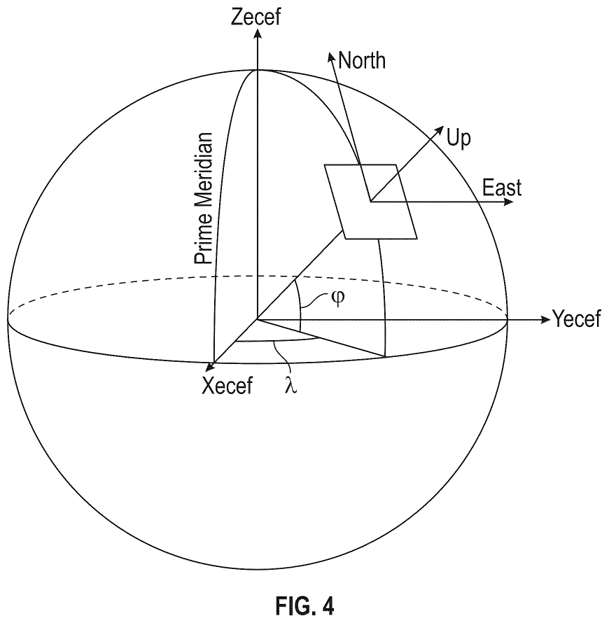

FIG. 4 is a visualization of the Local Tangent Plane (LTP). The local tangent plane may be used to approximate the surface of the Earth at a given point. The LTP may be described in a 3D Cartesian coordinate systems (X,Y,Z) such as the Earth-Centered, Earth-Fixed (ECEF) coordinate system as shown (X_{ECEF}, Y_{ECEF}, Z_{ECEF}) where the Z-axis is perpendicular to the plane, pointing away from the center of the Earth at the point of tangency while the X and Y axes lie within the plane. The ECEF coordinate system is especially useful for geolocation systems including global positioning systems.

FIGS. 5A, 5B, and 5C illustrate reference frames from different views of the vehicle. In each of these figures there is a global reference frame 200, a vehicle reference frame 202, a camera reference frame 204, a vehicle position 206, and camera translation calibration 208.

In FIG. 5A, a top view of the vehicle is shown illustrating the yaw angle, Ψ, as well as the angular calibration, Ψ_{c} with respect to the reference frames. In FIG. 5B, a side view of the vehicle is shown illustrating the pitch angle, Θ, as well as its angular calibration, Θ_{C}. In FIG. 5C, a rear view of the vehicle is shown illustrating the roll angle, Φ, as well as its angular calibration, Φ_{c}.

The methodology shown and described has a number of different use cases. Where the object is an agricultural field, some examples of uses cases include row following, automatic drift correction, and mapping weed, pest, and disease pressures.

### Row Following

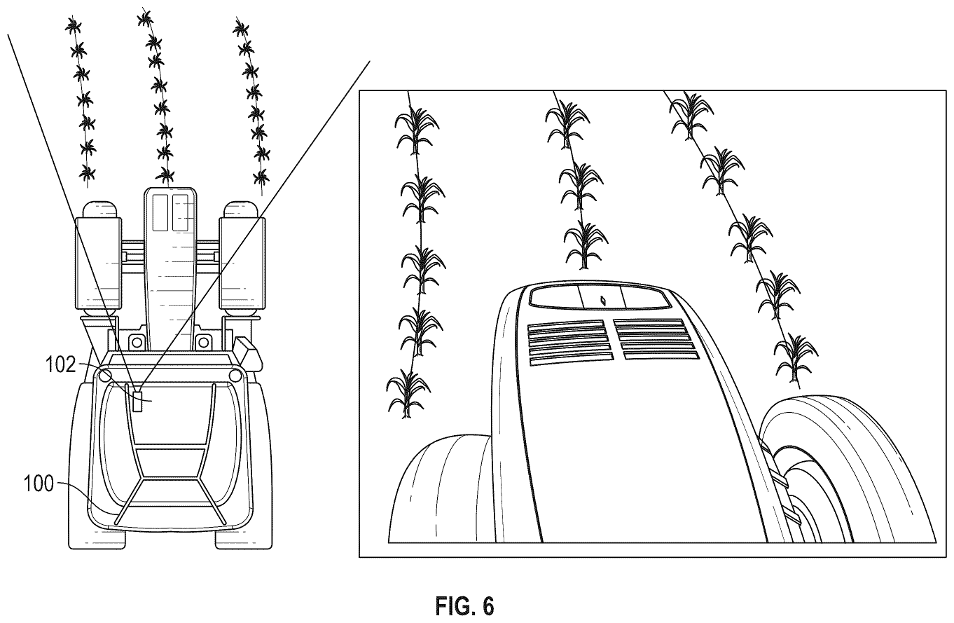

Generating geodetic positions for plants in each row of a row crop allows generating a guidance line to steer between them. FIG. 6 demonstrates how curve fitting in global coordinates is consistent for each row, while in pixel space the perspective warp causes each row to appear to have a different curvature. This provides a substantial improvement in the ability to reason about the rows such as eliminating weeds or volunteer plants which are between the rows.

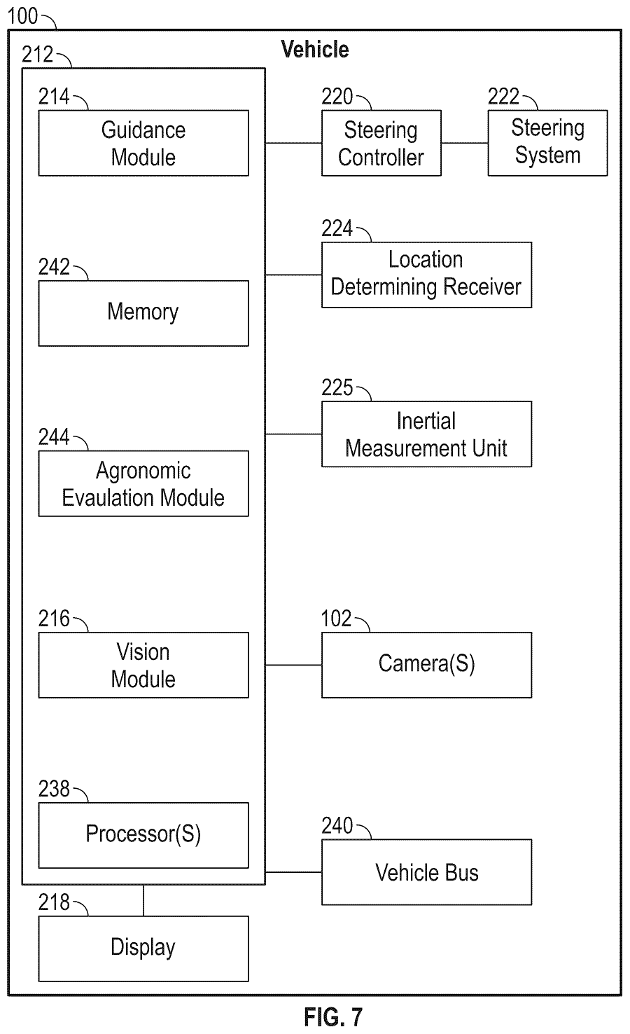

FIG. 7 illustrates one example of a system which may be used to implement the methodology. The process of FIG. 1, for example, may be implemented in instructions which are performed by the vision module 216 which is operatively connected to a camera 102. The vision module 216 may be stored in the memory 242 and executed by the processors 238 as a part of a control system 212. Position information may be obtained from the location determining receiver 224 which may, for example, be a GPS receiver. Position information including orientation information may also be obtained from an inertial measurement unit (IMU) 225 such as may be used in conjunction with the location determining receiver 224. The location determining receiver alone or in combination with an IMU may also be collectively called a location determining device.

The control system 212 associated with the vehicle 100 may provide for various functions including guidance which may be performed using the guidance module 214, agronomic evaluation which may be performed by the agronomic evaluation module 244 or other functions. A steering controller 220 and steering system 222 may also be operatively connected to the control system 212 such as to allow for automation. A vehicle bus 240 may also be operatively connected to the controls system 212. In some use cases, field operations may be performed by sending control signals over the vehicle bus. A display 218 is shown which is operatively connected to the control system 212 and may be used to display information such as guidance lines, results of agronomic evaluation, or other information. Thus, in the row following example, guidance lines may be constructed, and autonomous steering or other operations may be performed using the methodology to identify location of plants within a crop row.

### Automatic GPS Drift Correction

In another example, automatic GPS drift correction may be performed. By detecting an in-field fiducial which is surveyed and has an absolutely known GPS coordinate this process can locate that feature in geodetic coordinates as seen by the GPS system on the vehicle. The error between the known position and the located position allows us to correct the error in the vehicle born GPS. U.S. Pat. No. 11,315,258 (hereby incorporated by reference in its entirety) discloses an optical system for tracking the heading and position of an implement compared to the pulling tractor. However, here the method is advantageous as that disclosure involves visually detecting that the vehicle is at a known location whereas here, only visually seeing (with the camera) the known location (of the in-field fiducial) is needed as opposed to needing to position the vehicle at a known location (e.g. park at the known location).

### Weed, Pest, and Disease Pressure

According to another example, this methodology may be used when combined with other methods capable of finding specific weeds, pests or plant diseases. Such methods are known such as may be performed using image processing algorithms to identify particular colors, patterns, or other visual indicators of weeds, pests, or disease. Because the methodology allows for precise locations to be determined, including precise locations of specific plants (weeds or crops), specific location of crops having a condition associated with pests or plant diseases, or otherwise, precise mapping may be performed. It should be appreciated that such a highly accurate map may be used in any number of different ways including to generate a prescription map for spraying or other chemical application, a cultivation map, or even in applications such as estimating yield based on these yield robbing pressures. Thus, combined with other methods capable of finding specific weeds, pests or plant diseases this process allows generating a highly accurate map of the location, spread and severity of yield reducing pressures. It is to be understood that such mapping may be performed onboard a vehicle using the control system 212 as shown in FIG. 7. Where such mapping occurs in real-time or near real-time, it may be displayed on the display 218. Alternatively, such mapping may be post-processed at a later time. For example, relevant location data and corresponding imagery may be uploaded into the cloud for processing at a server, or other remote computing device. Alternatively, it may be stored on a storage device and later transferred for post-processing on another computing device.

### Off Vehicle Position Recording

A further example is where the feature of interest is another vehicle or implement. Thus, another vehicle or implement may be identified visually and the position, heading, and velocity of the additional vehicle or implement may be tracked with high accuracy and could be logged for further use. Thus, for example, where multiple vehicles are being used in the same field, one vehicle may be configured to track the other vehicle(s) and such information may be used to coordinate operations between the vehicles, to avoid collisions, and to reduce or minimize any overlap of operations or travel paths between the vehicles without requiring communications between the two vehicles. By identifying another vehicle or implement visually, this process allows that separate vehicle or implement's position, heading and velocity to be tracked with high accuracy and also logged for further use, if desired. It should also be understood that as previously explained, the camera need not be mounted on the vehicle but may be otherwise mounted including to a stationary object. Therefore, a methodology for visually determining a location of a feature of interest has been shown and described. Although various embodiments or examples have been shown or described it is to be understood that numerous options, variations, and alternatives are contemplated.

The foregoing disclosure provides illustration and description but is not intended to be exhaustive or to limit the implementations to the precise form disclosed. Modifications may be made in light of the above disclosure or may be acquired from practice of the implementations. As used herein, the term “component” or “module” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Although different embodiments or examples are provided it is to be understood that elements of different embodiments may be combined.

Where processes include a set of steps it is to be understood that the steps do not necessarily need to be performed in the order provided unless context expressly requires it in order for the process to be operational.

Where terms such as “horizontally” or “vertically” are used, it is to be understood that such terms are being used as a manner of convenience and it should be understood that any orientation may be used.

The term “feature” when used in the context of a feature which is located according to the methodology shown and described herein includes any visually or optically identifiable feature. This may include a plant, a portion of a plant, a rock, tree, or other natural object, a vehicle, implement, building, or other person-made object or any portion of the natural or person-made object.

The term “agricultural machine” may refer to a self-propelled agricultural vehicle such as a tractor, self-propelled sprayer, or a combine. The term “agricultural machine” also encompasses implements such as towable implements, implements attached to the hitch, or implements attached to a tool bar of an agricultural vehicle, or other types of agricultural machines. The term “agricultural machine” also encompasses combinations of implements and self-propelled vehicles.

What is claimed is:

1. A method for visually determining a position within a global coordinate system for a feature of interest in an agricultural field, the method comprising steps of:
determining a position of an agricultural machine within the global coordinate system;
determining an orientation of the agricultural machine;
determining a camera position for a camera operatively connected to the agricultural machine and a camera orientation for the camera based on position offset from the position of the agricultural machine within the global coordinate system and orientation offset from the orientation of the agricultural machine;
acquiring imagery from the camera, the imagery including the feature of interest; and
at a processor, combining depth data associated with the imagery, pixel location of the feature of interest from the imagery, the camera position, the camera orientation, the position of the agricultural machine within the global coordinate system, and the orientation of the agricultural machine to locate the feature of interest by providing visually derived coordinates within the global coordinate system.

2. The method of claim 1 wherein the feature of interest is a plant.

3. The method of claim 2 further comprising performing a crop row following operation within the agricultural field wherein the visually derived coordinates for the plant are used in performing the crop row following within the agricultural field.

4. The method of claim 1 further comprising performing an agricultural operation within the agricultural field using the visually derived coordinates within the global coordinate system for the feature of interest.

5. The method of claim 1 further comprising repeating the steps a plurality of times and for each time storing the visually derived coordinates for use in a subsequent operation.

6. The method of claim 1 wherein the feature of interest is a known in-field fiducial and wherein the method further comprises comparing the visually derived coordinates of the known in-field fiducial to surveyed coordinates for the known in-field fiducial and correcting the visually derived coordinates within the global coordinate system.

7. The method of claim 1 wherein the position and the orientation of the agricultural machine are determined based on a combination of GPS location data associated with a GPS antenna associated with the agricultural machine and inertial data associated with an inertial measurement unit (IMU) associated with the agricultural machine.

8. The method of claim 1 wherein the agricultural machine comprises at least one of an agricultural vehicle and an agricultural implement.

9. The method of claim 1 wherein the depth data is determined with a depth sensor associated with the camera.

10. The method of claim 1 wherein the depth data is acquired through at least one of time-of-flight sensing, and lidar sensing.

11. The method of claim 1 wherein the pixel location is at a center of the feature of interest.

12. A system configured for visually determining a position within a global coordinate system for a feature of interest, the system comprising:
a camera for operatively connecting to an object;
a location determining device for determining a position of the object within the global coordinate system and orientation of the object;
at least one processor executing instructions to:
determine a camera position for the camera and a camera orientation for the camera based on position offset from the position of the object within the global coordinate system and orientation offset from the orientation of the object;
acquire imagery from the camera, the imagery including the feature of interest; and
combine depth data associated with the imagery, pixel location of the feature of interest from the imagery, the camera position, the camera orientation, the position of the object within the global coordinate system, and the orientation of the object to locate the feature of interest within the global coordinate system.

13. The system of claim 12 further comprising an agricultural machine wherein the camera is rigidly connected to the agricultural machine.

14. The system of claim 13 wherein the camera is a 3D camera.

15. A method for performing field operations within an agricultural field, the method comprising steps of
visually determining a position within a global coordinate system for a feature of interest within the agricultural field by determining a position of an agricultural machine within the global coordinate system, determining an orientation of the agricultural machine, determining a camera position for a camera secured to the agricultural machine based on position offset from the position of the agricultural machine, determining a camera orientation for the camera based on orientation offset from the agricultural machine, acquiring imagery from the camera including the feature of interest, and combining depth data associated with the imagery, pixel location of the feature of interest from the imagery, the camera position, the camera orientation, the position of the agricultural machine within the global coordinate system, and the orientation of the agricultural machine to locate the feature of interest within the global coordinate system; and
performing a field operation within the agricultural field based on the position within the global coordinate system for the feature of interest.

16. The method of claim 15 wherein the field operation is performed by the agricultural machine.

17. The method of claim 15 wherein the field operation is performed by a machine different from the agricultural machine.

18. The method of claim 15 wherein the agricultural machine comprises at least one of an agricultural vehicle and an agricultural implement and wherein the feature of interest comprises a plant.

19. The method of claim 18 wherein the field operation is a crop row following field operation performed within the agricultural field and wherein the position for the plant is used in performing the crop row following field operation within the agricultural field.

20. The method of claim 15 wherein the feature of interest is a known in-field fiducial and wherein the method further comprises comparing the location of the known in-field fiducial to surveyed coordinates for the known in-field fiducial and correcting the location within the global coordinate system.
